(19) United States
(12) Patent Application Publication
(10) Pub. No.: US 2009/0172167 A1
(43) Pub. Date: Jul. 2, 2009

(54) System and Method for a CDN Balancing and Sharing Platform

(76) Inventors: David DRAI, Kfar Yona (IL); Udi TRUGMAN, Alfe-Menashe (IL); Ronni ZEHAVI, Tel-Mond (IL)

Correspondence Address: DR. D. GRAESER LTD., 9003 FLORIN WAY, UPPER MARLBORO, MD, 20772, US

(21) Appl. No.: 12/344,582

(22) Filed: Dec. 28, 2008

Related U.S. Application Data
(60) Provisional application No. 61/006,151, filed on Dec. 26, 2007.
(60) Provisional application No. 61/129,213, filed on Jun. 11, 2008.

(30) Foreign Application Priority Data
Oct. 24, 2008 (GB) GB0819529.9

(51) Int. Cl. G06F 15/173

(52) U.S. Cl. 709/226

(57) ABSTRACT

A method for managing content distribution resources for a customer, including: providing a CDN (content distribution network) center for managing content distribution; providing a plurality of CDNs; providing content of the customer to be distributed; and selecting at least one of said plurality of CDNs for distributing the content by said CDN center.

### CROSS-REFERENCES TO RELATED APPLICATIONS

This Application claims priority from: U.S. Provisional Application No. 61/006,151, filed on Dec. 26, 2007; U.S. Provisional Application No. 61/129,213, filed on Jun. 11, 2008; and United Kingdom Patent Application No. GB 0819529.9, filed on Oct. 24, 2008, all of which are hereby incorporated by reference as if fully set forth herein.

### FIELD OF THE INVENTION

The present invention relates to a system and a method for a CDN (content distribution network) balancing and sharing platform, and in particular, to such a system and method which enable management of resources for content distribution.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. Unsurprisingly, Web pages have also become popular for viewing and/or providing various types of content, including content which is downloaded to the computer of a requesting user and/or is displayed through the Web browser of the user's computer. However, in order for such content to be made available to the user, it needs to be distributed from some type of distribution location, such as a server for example.

A CDN (content distribution network) is frequently used for providing such content to the user's computer. Such networks provide more efficient and cost-effective distribution to the computers of such end users. Typically, a CDN distributes content for many different customers, which then pay a CDN vendor for such distribution. A customer may use more than one CDN vendor. Unfortunately, CDNs are currently used in an all or nothing manner, in which content is either distributed through a CDN or is not provided to a CDN. There is no flexibility or redundancy between the CDNs. There is also no ability to reduce cost dynamically.

### SUMMARY OF THE INVENTION

There is an unmet need for, and it would be highly useful to have, a system and a method for a CDN (content distribution network) balancing and sharing platform. There is also an unmet need for, and it would be highly useful to have, such a system and method which would support load balancing between multiple CDNs.

There is also an unmet need for, and it would be highly useful to have, a system and a method for content distribution through a multi-CDN sharing platform.

There is also an unmet need for, and it would be highly useful to have, a system and a method which enable management of resources for content distribution.

The present invention overcomes these drawbacks of the background art by providing a system and method for content distribution which enables content to be optionally and preferably distributed through one or more of a plurality of CDNs (content distribution network; also termed content delivery network), which may also be termed CDN load balancing; however, the present invention is not limited to such an application, as other applications are contemplated within the scope of the present invention in at least some embodiments, for example with regard to the operation of software applications in a distributed manner. Therefore, the system and method provide a platform for multi-CDN balancing and sharing for content distribution and/or for other types of distribution (as for example operation of software applications). However, without wishing to be limiting in any way, the description of preferred embodiments herein centers around the distribution of content.

According to some optional embodiments, the system and method of the present invention provide for distribution through any one of a plurality of CDNs and/or a customer distribution resource of the customer requesting distribution of the content and/or through a customer distribution resource of a customer other than the customer requesting distribution of the content.

Optionally and preferably, content is allocated between one or more of multiple CDNs and/or between one or more customers and a CDN (or one or more CDNs) in order to achieve optimal content distribution according to one or more parameters.

According to some embodiments of the present invention, there is provided a method for managing content distribution resources for a customer, comprising: Providing a CDN center for managing content distribution; Providing a plurality of CDNs; Providing content of the customer to be distributed; and Selecting at least one of the plurality of CDNs for distributing the content by the CDN center.

Preferably the method further comprises providing a customer edge and a partner edge; and determining whether to distribute content from the customer by the partner edge or the customer edge.

Preferably the method further comprises distributing the content through at least one of the CDN or the customer edge. Optionally, the determining whether to distribute the content is performed according to a policy of the customer. Also optionally, the policy includes a limit on bandwidth sharing. Optionally, the limit is determined at least partially according to cost. Preferably, the policy includes a requirement for quality of experience. Optionally, the policy further includes a requirement for cost limit. Optionally, the policy further includes a requirement for redundancy of content delivery mechanisms.

The above method is preferably optimized for manageability of content delivery.

Preferably the method further comprises predicting bandwidth usage by the customer edge and the partner edge by the CDN center to determine any unused bandwidth; and selecting one or more of the customer edge and the partner edge according to availability of unused bandwidth.

Optionally, the predicting the bandwidth usage comprising collecting one or more statistics of bandwidth usage of each customer; and analyzing the one or more statistics.

Preferably, the one or more statistics are selected from the group consisting of bandwidth used in the past hour, bandwidth used in the past 24 hours, bandwidth used in the past week, bandwidth used in the past month and real time bandwidth usage.

More preferably, the predicting the bandwidth further comprises determining whether current bandwidth usage represents a peak such that sharing with at least one other customer is not performed.

Most preferably, the predicting the bandwidth further comprises determining a deviation from historical bandwidth usage; and predicting future bandwidth usage according to actual bandwidth used and the deviation. Optionally, the determining the deviation further comprises comparing actual and historical bandwidth usage according to a statistical model.

Preferably the method further comprises providing a customer origin site; and determining whether to distribute content from the customer by the customer origin site.

Preferably the method further comprises providing a peer to peer content distribution mechanism; determining whether to distribute content from the customer by the peer to peer content distribution mechanism.

Preferably the method further comprises selecting a mechanism for distribution according to at least one balancing parameter.

Optionally, the selecting a mechanism for distribution further comprises balancing between a plurality of CDNs.

According to other embodiments of the present invention, there is provided a method for predicting bandwidth usage, comprising:

Measuring one or more of a plurality of statistics selected from the group consisting of bandwidth used in the past hour, bandwidth used in the past 24 hours, bandwidth used in the past week, bandwidth used in the past month and real time bandwidth usage;

Determining a deviation from historical bandwidth usage; and

Predicting future bandwidth usage according to actual bandwidth used and the deviation.

Optionally, the determining the deviation further comprises comparing actual and historical bandwidth usage according to a statistical model.

Preferably the method further comprises determining actual bandwidth usage; comparing the actual bandwidth usage to the predicted future bandwidth usage; and if different, then adjusting a further future prediction according to the difference.

Preferably the method further comprises determining whether a trend for current bandwidth usage is for a peak.

According to other embodiments of the present invention, there is provided a method for content distribution to an end user for one of a plurality of customers, the method comprising:

Obtaining information regarding the end user, the information including a geographical location and a desired content related activity;

Determining a list of potential routing targets, wherein at least one potential routing target is controlled by a partner and wherein at least one potential routing target is controlled by a CDN (content distribution network); and

Selecting at least one routing target according to a selection policy, wherein the selection policy includes a parameter related to resource sharing for content distribution.

Optionally, the selecting the at least one routing target further comprises:

Determining a route for providing the information to the end user; and

Selecting the at least one routing target at least partially according to the route.

Optionally, the determining the route is performed according to one or more of a result of a bandwidth prediction algorithm; edge monitoring; BGP (Border Gateway Protocol) result; actual physical route being used; latency of the route; popularity of the information; and cost of the route.

Optionally, the at least one routing target is further selected according to one or more of a low distance or a low latency separation from the distribution center by the end user.

Optionally, the routing target is selected according to an anycasting protocol response.

According to other embodiments of the present invention, there is provided a method for sharing content distribution resources between content distribution networks (CDNs), comprising:

Providing a management center for managing content distribution for a plurality of CDNs;

Predicting bandwidth usage by each CDN by the management center to determine any unused bandwidth; and

determining whether to distribute content from at least one CDN according to the unused bandwidth.

According to other embodiments of the present invention, there is provided a system for content distribution, comprising:

A CDN center;

A plurality of customer edges; and

A CDN edge;

Wherein the CDN center determines whether to distribute the content through the CDN edge or through one of the customer edges.

Optionally the system further comprises a plurality of CDN edges from a plurality of CDN vendors, wherein the CDN center further determines whether to distribute the content through one of the plurality of the CDN edges or through one or more of the customer edges, or a combination thereof.

Without wishing to be limited in any way, various embodiments of the present invention solve the drawbacks of the background art with regard to content distribution, including but not limited to one or more of using CDNs in a flexible manner (rather than in an all or nothing manner, in which content is either distributed through a CDN or is not provided to a CDN, as for the background art); providing for redundancy between the CDNs; reducing cost dynamically; sharing a customer content distribution resource with one or more CDNs (to reduce costs); managing content distribution through multiple CDNs and/or customer resources by or for a customer, in a customer centered manner; optimizing content flow to the optimal content distribution resource, such as the optimal CDN for example; and maximizing usage of a data center by a customer and/or partner of a customer. As termed herein, partners are customers with same interest in terms of data centers and/or content and a shared interest in maximizing their benefit.

Unless otherwise defined, all technical and scientific terms used herein have the same meaning as commonly understood by one of ordinary skill in the art to which this invention belongs. The materials, methods, and examples provided herein are illustrative only and not intended to be limiting. Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player, ATM (machine for dispensing cash), POS credit card terminal (point of sale), electronic cash register. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A and 1B are schematic block diagrams of an exemplary system according to some embodiments of the present invention;

FIG. 2 is a flowchart of an exemplary method for providing data to an end user according to some embodiments of the present invention;

FIGS. 3A-3B show a system and method for determining content delivery availability according to some embodiments of the present invention;

FIG. 4 relates to an exemplary, illustrative method according to some embodiments of the present invention for routing; and

FIG. 5 shows a schematic block diagram of an exemplary, illustrative central manager according to some embodiments of the present invention.

### DETAILED DESCRIPTION

The present invention, in some embodiments, is of a system and a method for efficient, dynamic resource management for content distribution, preferably as part of a platform. In some embodiments, the present invention relates to a method and system for load balancing for a plurality of CDNs, by optionally and preferably distributing content through one or more of the plurality of CDNs according to one or more distribution parameters.

Optionally and preferably, content is allocated between one or more of multiple CDNs and/or between one or more customers and a CDN (or one or more CDNs) in order to achieve optimal content distribution according to one or more parameters.

According to some embodiments for resource sharing for content distribution, such sharing may optionally and preferably be performed between customers (ie customer edges), between a customer and a CDN, and between different geographical locations for a customer with multiple edges and the CDN. Optionally, any of the above configurations for the sharing platform may include a storage service which is separate from any type of content distribution service; a non-limiting example is the storage service of Amazon.com, although optionally any storage service may be incorporated. The storage service preferably is connected to a computer network and is more preferably connected to the Internet.

According to preferred embodiments of the present invention, there is optionally and preferably provided a system comprising a CDN center, preferably featuring a CDN balancer for balancing the load of content distribution between a plurality of CDNs. The system also preferably features a plurality of CDN edges from different CDNs, as well as a customer edge and a customer center.

In the background art, a CDN system would typically feature a CDN center but without the CDN balancer, a CDN edge and a customer center. Also the background art system would not feature a plurality of CDN edges from different CDNs, as the background art does not teach or suggest distribution across a plurality of CDNs, and certainly does not teach or suggest load balancing across a plurality of CDNs or management of content distribution from a CDN center across a plurality of CDNs.

Turning back to the above embodiments of the present invention, the system optionally features content distribution from a particular customer through a sharing platform, which may optionally provide for sharing of content distribution through a plurality of different customer edges (optionally including a customer edge of a customer other than the particular customer having the content to be distributed, such as a partner edge for example). Such a sharing platform may optionally and preferably be combined with the platform for content distribution through a plurality of different CDNs.

The system preferably features measurement of one or more of the following parameters for a customer having content to be distributed: customer bandwidth; customer distribution availability; determining whether to share the CDN traffic between partners and the customer; and determining whether to share the CDN traffic between the customer and the CDN. For the last parameter, optionally end users (or rather end user computers) with proximity to the Customer Center are provided content directly from the Customer Edge while other end users are served by the CDN edges. Proximity may optionally be determined in terms of geographical proximity and/or some other type of proximity, such as speed of receipt of the content for example.

Such parameters may optionally be determined by the customer edge or by the CDN center, or a combination thereof. Regardless of which component(s) of the system measure or determine such parameters, the CDN balancer in the CDN center preferably selects the optimal delivery method, which may optionally and preferably include selection of the optimal CDN for delivery for example, and/or may optionally (alternatively or additionally) include selection of another delivery mechanism, such as a customer edge, a partner edge or the like. In any case, the delivery mechanism selected optionally and preferably provides for one or more of redundancy, cost saving and/or better quality of experience.

As defined herein, the term “customer edge” refers to an on-line distribution facility for content, such as a server, a plurality of servers and so forth, without regard to the physical location of the server or servers. It should also be noted that a “server” as defined herein may optionally be a physical device, a software appliance or application, a group and/or cluster of devices and/or software appliances and/or applications and so forth.

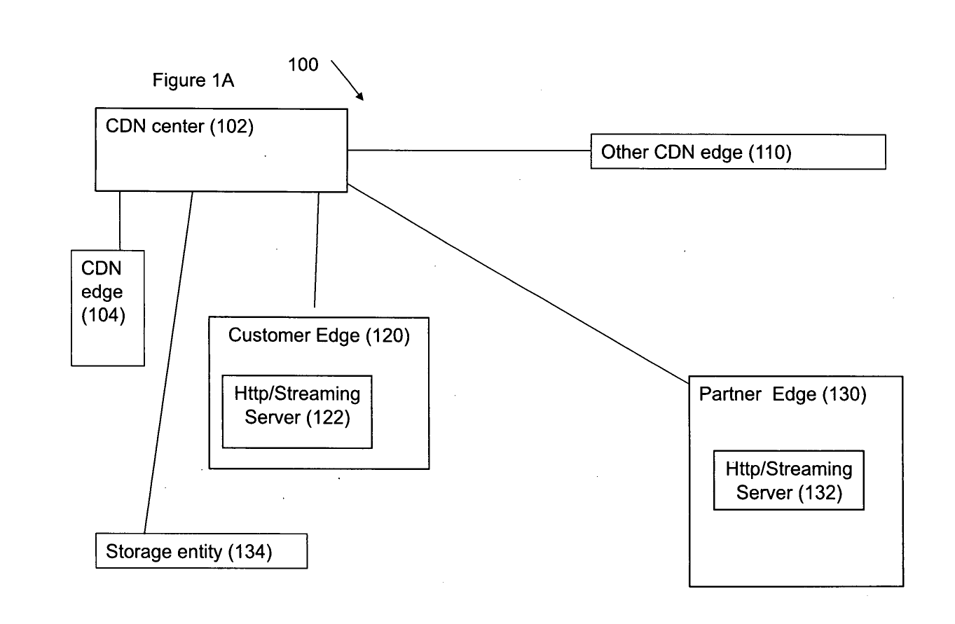

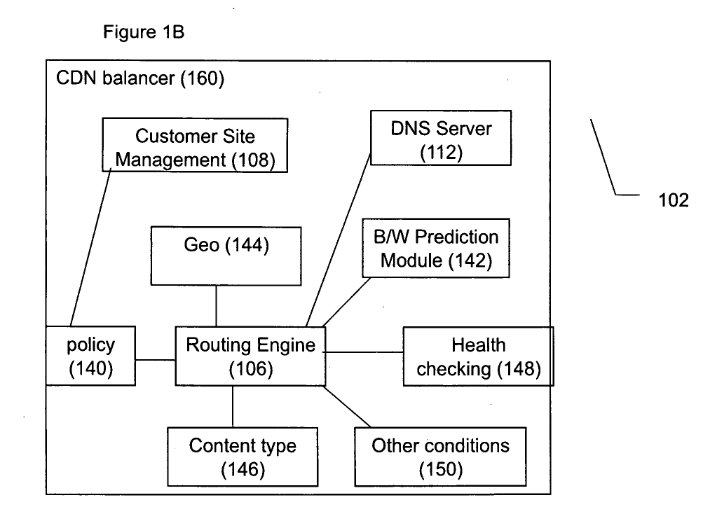

The principles and operation of the present invention may be better understood with reference to the drawings and the accompanying description. Referring now to the drawings, FIG. 1A is a schematic block diagram of an exemplary system according to the present invention for a content distribution platform. As shown, a system 100 preferably features a CDN center 102, which in turn is connected to a CDN edge 104 and a customer edge 120. In addition, optionally a storage entity 134 is connected to CDN center 102. Collectively, these components of system 100 may be described as a content distribution network (CDN). Preferably, these components of system 100 are also in communication with another CDN for load balancing; such a connection is shown between CDN center 102 and another CDN edge 110. The components of system 100 are connected through some type of network, such as a computer network, which optionally and preferably at least includes the Internet (more preferably with one or more internal networks; not shown). CDN center 102 may optionally be termed a management center.

CDN center 102 preferably supervises content distribution through one or more components as shown for managing content distribution, preferably including one or more of CDN edge 104 and/or CDN edge 110 of a different CDN (which is preferably also related to a different CDN vendor than CDN edge 104), as well as optionally (additionally or alternatively) through customer edge 120. A CDN vendor comprises one or more CDN networks and preferably also manages such one or more networks.

According to some optional embodiments of the present invention, system 100 optionally also features a partner edge 130. As described previously, a partner preferably has some type of relationship with and/or connection to the customer, such that content of the customer may optionally be distributed through partner edge 130 as described herein. Therefore, content may optionally be distributed (additionally or alternatively) through partner edge.

The optimal edge for delivering content is preferably selected by CDN center 102, for example by selecting between one or more of customer edges 120 or 130, and/or by selecting between CDN edge 104 and an alternate CDN and/or CDN vendor as represented by another CDN edge 110.

Customer edge 120 and partner edge 130 each preferably includes an HTTP/streaming server 122 and 132, respectively. HTTP/streaming server 122 or 132 may optionally support any suitable computer network protocol, such as any suitable Internet protocol for example, and not only HTTP and/or data streaming.

Each of customer edge 120 and partner edge 130 is preferably located at the facilities of the customer who wishes to distribute data, such as content, or otherwise wishes to make use of the bandwidth provided by the bandwidth vendor; for this example, it is assumed that each of customer edge 120 and partner edge 130 relates or belongs to a different customer. Customer edge 120 or partner edge 130 are preferably each more limited in terms of the constraints which it must obey, in particular with regard to potentially unexpected behavior by the customer which may cause downtime. Therefore, CDN center 102 preferably considers this lower reliability when routing requests through customer edge 120 or partner edge 130.

FIG. 1B shows an exemplary, non-limiting embodiment of CDN center 102 in more detail, featuring a CDN balancer 160. As previously described, CDN center 102 is optionally and preferably able to supervise distribution of content through a plurality of customer and/or partner edges and also a plurality of different CDN networks or vendors. Such supervision preferably includes determining the optimal edge for delivering content, preferably also including load balancing, for example by selecting between CDN 104 and/or alternate CDN 110 by CDN balancer 160. CDN balancer 160 preferably selects the optimal delivery method, which may optionally and preferably include selection of the optimal CDN for delivery for example, and/or may optionally (alternatively or additionally) include selection of another delivery mechanism, such as a customer edge, a partner edge or the like, each of which may optionally be described herein as a routing target. In any case, the delivery mechanism selected optionally and preferably provides for one or more of redundancy, cost saving and/or better quality of experience.

Routing engine 106 preferably operates a prediction algorithm which calculates the expected bandwidth sharing to each routing target. Such a calculation enables more effective bandwidth use through sharing of resources for content distribution, as described in greater detail below.

Customers are preferably able to set one or more parameters for content distribution through a policy module 140, shown as being part of CDN balancer 160 but which may optionally be external to CDN balancer 160 (for example elsewhere in CDN center 102). As described in greater detail below, the policy optionally and preferably relates to one or more parameters including but not limited to budget, speed of distribution, “quality of experience” and so forth, which shape the manner and route in which content is delivered. CDN balancer 160 preferably uses the one or more parameters from policy module 140 to determine the optimal edge for content delivery, which may optionally be located at any of the previously described routing targets. Optionally, if a routing target is an alternative CDN or CDN vendor, then the CDN or vendor itself may be the routing target, rather than a specific edge.

The optimal route preferably is determined according to a plurality of parameters, optionally and more preferably including but not limited to the examples provided herein, optionally and preferably by routing engine 106. For example, routing engine 106 preferably determines the geographical relation of the one or more potential routing targets through a geo module 144. CDN balancer 160 also preferably operates a BGP (Border Gateway Protocol) which is an Internet protocol for determining a map of autonomous systems, which may for example be ISPs (Internet Service Providers), computer networks of companies and organizations, and so forth (BGP is the core routing protocol of the Internet).

Routing engine 106 also preferably considers one or more characteristics of the content itself, through a content type module 146. Such characteristics are preferably considered with regard to the one or more parameters of policy module 140.

Routing engine 106 preferably is able to determine the amount of bandwidth being used by one or more routing targets according to the results of a bandwidth prediction algorithm as provided by a bandwidth prediction module 142.

Routing engine 106 also preferably considers edge monitoring (for example optionally and preferably to determine the status or “health” of the edge as described in greater detail below, and as shown through health module 148) and/or monitoring of the function(s) of one or more other components of system 100.

Routing engine 106 preferably also considers the actual physical (ie hardware) route being used, optionally and preferably including with regard to reliability, latency and other parameters, for example through an other conditions module 150 that relates to any other conditions of interest.

CDN center 102 preferably comprises a Customer Site Management module 108, which gives customers the ability to control one or more parameters related to content delivery, for example optionally including but not limited one or more of customer cache settings (expiration etc.), alerts for excessive bandwidth use, customer edge malfunction and so forth. Customers are also preferably able to view one or more aspects of the provided service, for example with regard to one or more reports, graphical or other information through a “dashboard” or other display, and the like. Customer Site Management module 108 is shown as being part of CDN balancer 160 but may optionally be located externally to CDN balancer 160, for example elsewhere in CDN center 102.

A DNS server 112 provides domain name look-up services to routing engine 106.

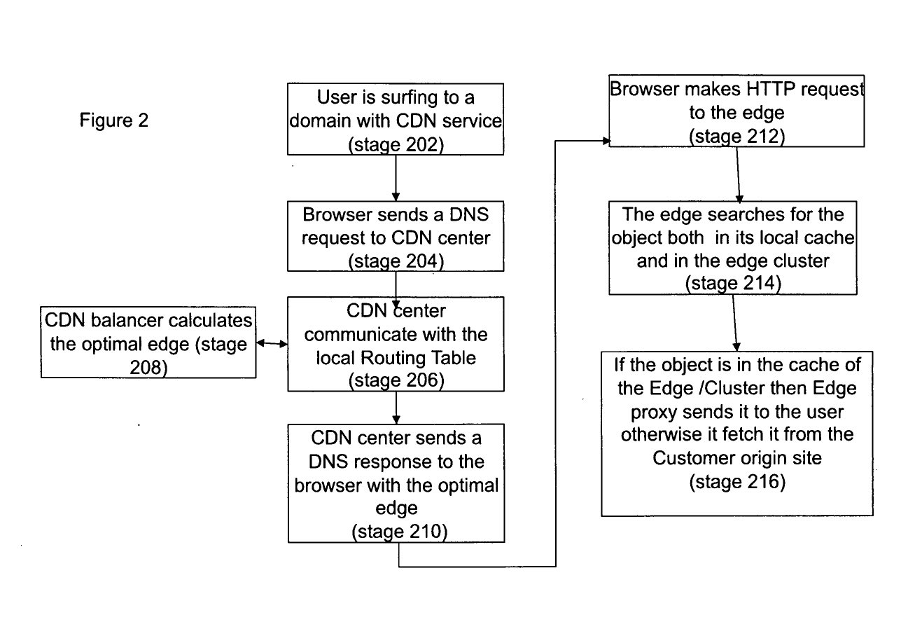

The operation of system 100 may optionally be performed as described with regard to FIG. 2, which is a flowchart of an exemplary method for providing data to an end user. It should be noted that although the method is described with regard to the non-limiting example of a web browser, in fact any client may optionally be used with this method. In stage 202, the method begins with the user surfing to a domain with content delivery service. By “surfing” it is meant that the user typically operates a web browser and causes the web browser to display a web page which may optionally be the content itself and/or which may optionally provide the option for obtaining or providing content. In stage 204, the web browser of the user sends a DNS request, for example to the previously described CDN center. The CDN center requests the optimal route available through the local routing table in stage 206; optionally and preferably, in stage 208, the CDN balancer calculates the optimal edge path based on bandwidth prediction and more preferably also policy. However, optionally and alternatively, stage 208 is not performed and instead a static look-up table is used.

In stage 210, according to the information received regarding routing, the CDN center sends a DNS response to the web browser which includes the optimal edge from which the data may be obtained. In stage 212, the web browser sends an HTTP request to this edge, which may optionally be a partner edge or a customer edge, or a CDN edge. In stage 214, the edge then searches for the object requested in the HTTP request, preferably both in its local cache and also optionally in an associated edge cluster. The edge cluster is preferably a plurality of edges; if the edge cannot locate the object in the local cache, then the edge preferably searches for the object in one or more other members (edges) of the edge cluster.

If the object is located in the local cache or in the edge cluster, then the edge preferably delivers it to the web browser (ie to the user) in stage 216. Otherwise the edge sends a request to the customer origin site to provide this object, such that the customer origin site preferably provides directly to the web browser. Preferably, requests to the customer origin site are avoided unless necessary (for example, the edge cannot locate the object locally), in order to avoid excessive bandwidth to the origin site. It should be noted that a customer edge may be located at the customer, in addition to the origin site; however, the customer edge is designed for such requests and use of bandwidth.

The above described system and method of FIGS. 1 and 2 demonstrates the potential for content distribution in an architecture which includes the customer site but which also includes components outside of the customer site. All of these components operate together in an interactive manner to provide bandwidth for content distribution. Because these components operate interactively, it is possible to predict bandwidth use by any given customer and to enable sharing of resources for content distribution with other customers.

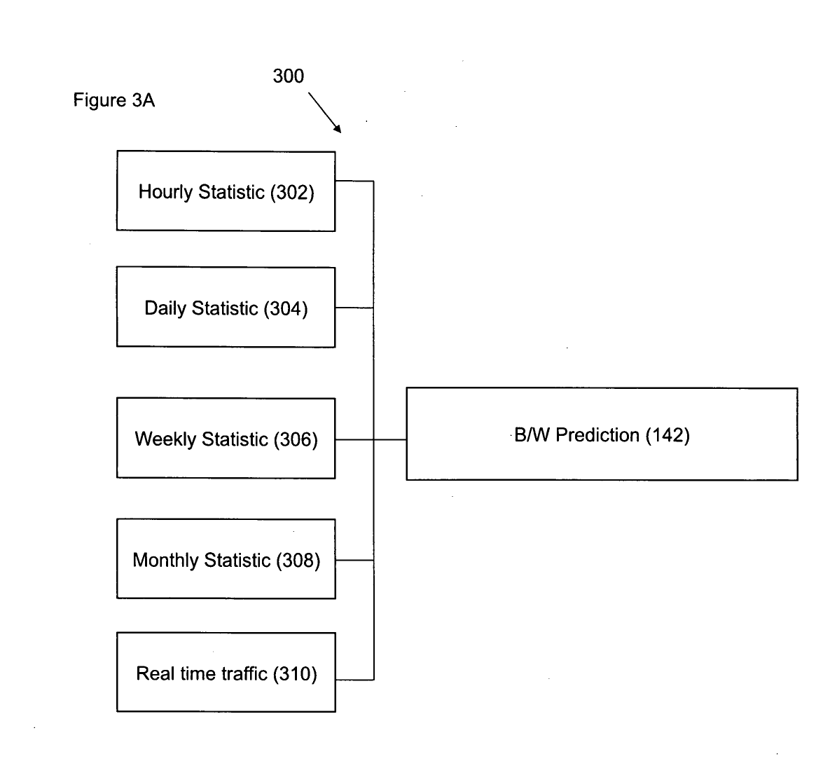

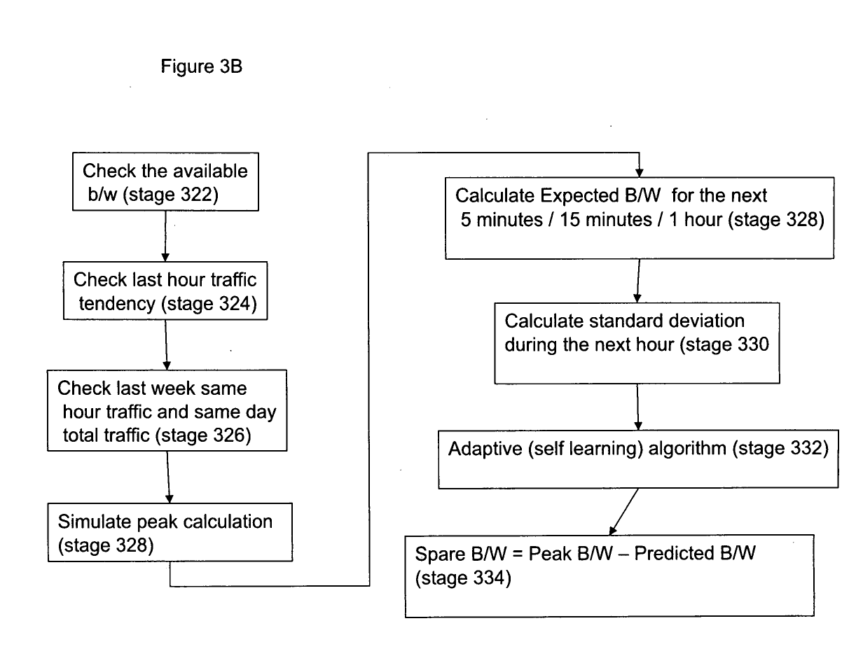

FIGS. 3A-3B describe optional, exemplary, illustrative implementations of a system and method according to some embodiments of the present invention for bandwidth usage prediction.

FIG. 3A shows the previously described bandwidth prediction module 142 in more detail, which may optionally operate with the system of FIG. 1, which preferably receives one or more statistics regarding actual bandwidth usage by each customer and/or CDN edge and/or CDN and/or CDN vendor. These statistics preferably include but are not limited to, an hourly statistic 302 (regarding data collected in the past hour), a daily statistic 304 (regarding data collected in the past 24 hours), a weekly statistic 306 (regarding data collected in the past week), a monthly statistic 308 (regarding data collected in the past month) and also an analysis of real time traffic 310, which relates to the actual level of bandwidth usage by the customer in real time.

Bandwidth prediction module 142 supports sharing the CDN traffic between one or more partners and the customer, and/or between the customer and the CDN.

FIG. 3B shows a flowchart of an exemplary method according to the present invention for bandwidth prediction by bandwidth prediction module 142 according to the above information. In stage 322, the amount of currently available bandwidth is determined, by sampling the SNMP (simple network management protocol) counters or any other measure of bandwidth usage at the customer origin site. In stage 324, the traffic experienced in the last hour is considered to determine a traffic tendency (ie whether it is increasing or decreasing, as well as the absolute level). In stage 326, statistics for the same hour and day on the previous week are also examined, for the purpose of comparison, to determine whether current traffic is similar to historical trends. These different statistics are then preferably combined to predict a peak level for the traffic and also to determine the difference (if any) between such a peak and the current level of traffic. The peak may optionally be calculated according to any method, including but not limited to the known in the art method of determining whether the level of traffic is 95% of a maximal traffic level.

The expected bandwidth is then calculated for at least one and preferably a plurality of time periods, based on the determination of the historical relationship and also whether a peak is being observed in stage 328; for example, the time periods optionally and preferably include 5 minutes, 15 minutes and 1 hour.

The expected deviation during the next hour is then calculated in stage 330, preferably according to a statistical model, such as for example a standard deviation, a calculation according to a statistical model which encompasses the potential for highly unusual and/or improbable behavior, and so forth. An adaptive (self learning) algorithm then considers the expected amount of bandwidth to be used in stage 332 by at least considering the expected standard deviation from previous predicted bandwidth usage but more preferably by considering all of the above factors. The algorithm is preferably also able to consider whether usage would be unexpectedly high or low, by learning from previous situations regarding bandwidth usage at least for this customer, but optionally shared from learning about the behavior of other customers as well in the aggregate and/or according to the type of customer, for example. Seasonal data may also optionally be incorporated regarding previously experienced spikes or decreases in bandwidth usage, or other bandwidth usage differentials, for a particular customer.

In stage 334, the amount of spare (and hence available) bandwidth is preferably determined by subtracting the predicted bandwidth usage expected at this current time for this customer from the peak bandwidth usage previously calculated for this customer.

In order to further increase the efficiency of bandwidth distribution across the system and also prevent overloading or failure, the above bandwidth usage prediction is also optionally incorporated into the load balancing algorithm used to determine which component(s) of the system is to be selected for content distribution.

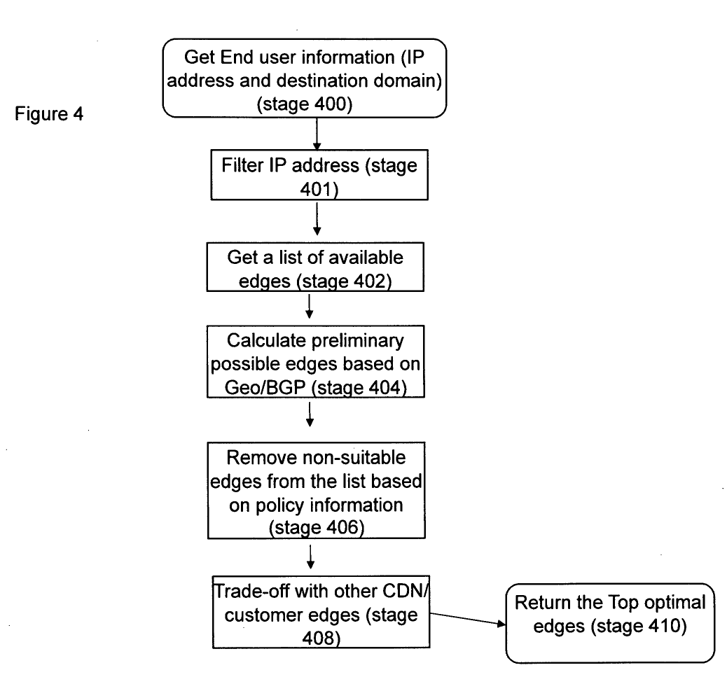

FIG. 4 relates to an exemplary, illustrative method according to some embodiments of the present invention for operation of the CDN balancer of the system of FIG. 1. In stage 400, the end user information is obtained (for example for a computer operating a web browser which is making an HTTP request); this information preferably includes the IP address of the computer making the HTTP request and also the destination domain.

In stage 401, optionally, the IP addresses of specific end users and/or subnet are filtered and/or compared to determine whether such IP addresses are blocked, for example if previous abusive behavior was demonstrated.

In stage 402, a list of available edges for providing the requested object or other content is determined. Preferably such a list is determined according to the destination domain, the IP address of the end user and so forth. More preferably the list is also determined according to the current “health” or operating status of the edge as well as according to previously determined “health” reputation for that edge. The latter may optionally include but is not limited to history of failure by the edge, reputation of the edge bandwidth provider and reputation of the edge hosting provider (if different from the bandwidth provider).

In stage 404, the above list of available edges is preferably reduced according to one or more geographical parameters and/or according to one or more parameters determined from BGP (Border Gateway Protocol), or any other routing information. Such routing information can be, for example a result of a bandwidth prediction algorithm; edge monitoring; actual physical route being used; latency of the route; popularity of the information; time based parameters; type of content; site health and cost of the route.

Next, non-suitable edges are preferably removed according to policy information in stage 406, such that one or more edges that cannot meet the one or more requirements of the policy are preferably removed. The policy information optionally and preferably includes but is not limited to QoE—Quality of experience. With regard to QoE, this parameter is preferably adjusted according to the required task; for example if the task is to download software, the real time performance is less critical, such that the requested task may be routed to non optimal but less expensive locations. The QoE preferably also includes a price tier model, such that customers willing to pay more to provide a higher quality experience to the end user are preferably routed to more expensive and efficient locations, in addition to routing according to the category of task to be performed.

If the customer has a private network or machine(s) for content delivery, then the CDN balancer may optionally give the task only to the specific customer edges.

In stage 408, optionally a trade-off is performed between using partner edges vs. customer edges, in which the latter are preferred within certain limitations (for example with regard to reliability or cost); the trade-off may also optionally consider CDN vs. customer edges and/or different CDNs, or any combination thereof. In stage 410, the CDN balancer provides the top optimal edge(s) for the task.

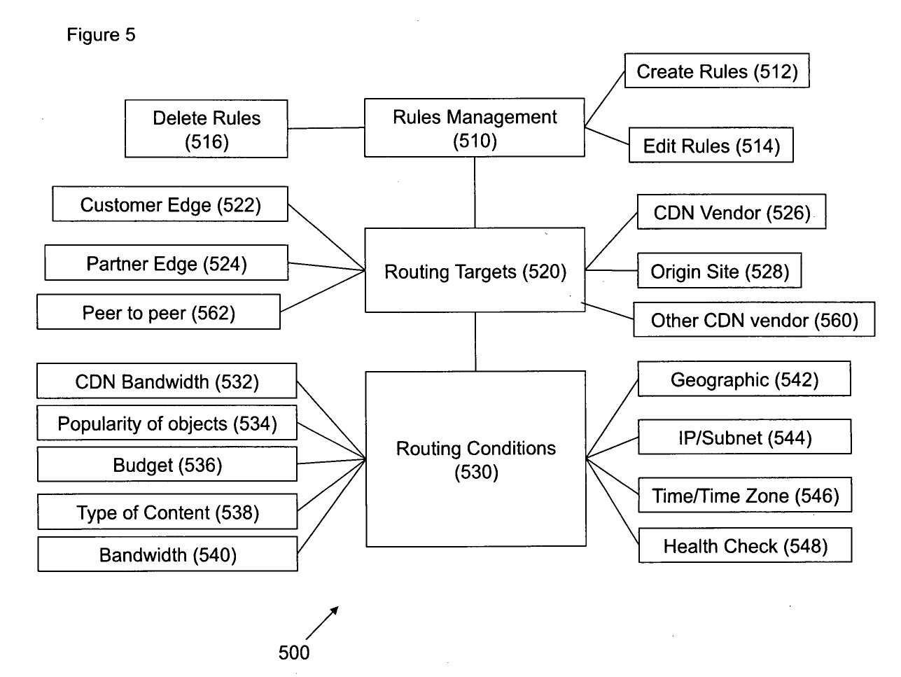

As previously described, overall control of an exemplary content distribution system and sharing platform according to the present invention preferably includes a central manager for managing such distribution, which for example is optionally and preferably the CDN balancer of FIG. 1. FIG. 5 shows a schematic block diagram of an exemplary, illustrative central manager according to some embodiments of the present invention. A central manager 500 preferably provides a comprehensive content distribution management solution, whether for multiple customers and/or for a single customer with multiple systems requiring separate applications requiring bandwidth usage for example with regard to distributed software execution, and/or content delivery and/or different end user patterns. Central manager 500 provides the optimal solution for all of these different requirements for content distribution. For example, the customer may optionally wish to set a policy in which the customer servers provide the content or otherwise the customer uses bandwidth from the customer's own facilities, without the use of external facilities, while in other situations, the customer may prefer to request specific external facilities for content distribution and hence for bandwidth usage (for example due to reliability, budget and so forth).

Central manager 500 preferably operates according to the interaction of three main modules: rules management 510, routing targets 520 and routing conditions 530.

Rules management 510 preferably includes the ability of the customer to create rules 512, edit rules 514 and delete rules 516. Furthermore, rules management 510 preferably also includes a list of priorities in which rules are to be applied, for conflict resolution. If different rules overlap or may potentially overlap, the customer preferably defines priorities for all created rules so that in case of conflicts the highest priority rule is applied.

Routing conditions 530 preferably includes geographic routing 542, which routes end users from a specific geographic area to one of the routing targets 520; IP based routing 544, which routes end users from specific IP/subnet to one of the routing targets 520; Time Based Routing 546 which routes end users based on specific hours and time zone to a specific routing targets 520; Type of Content Routing 538, which routes specific objects by type (i.e. type of media/object size/type of object or content and so forth) to one of the routing targets 520; bandwidth based routing 540, which routes end users based on origin bandwidth consumption (for example, a customer may select to use CDN services only from a specific bandwidth threshold to reduce costs, according to information from a budget module 536); selection of a routing target based on site health checking 548; customer bandwidth based routing 532 which routes end users based on the specific bandwidth consumption of the routing targets 520 (to control usage cost for bandwidth); and popularity based routing to route objects based on their popularity level to one of the routing targets 520.

Routing targets 520 preferably include one or more of a customer edge 522, a partner edge 524, a CDN (or other content) vendor 526, another (different) CDN (or other content) vendor 560, a peer to peer content distribution option 562, and a customer origin site 528. The selection is preferably made according to the rules of rules management 510 and also according to the routing conditions determined in routing conditions 530. Each of CDN vendors 526 or 560 may also optionally (additionally or alternatively) be any type of bandwidth vendor or provider.

The above central manager 500 (which may optionally be implemented as part of CDN balancer as described above) optionally and preferably provides for sharing the CDN traffic between partners and the customer (represented by customer edge 522 and partner edge 524) to preferably achieve one or more of the following: reduce cost; and support a partner which may have or may not have an edge in its CDN center. Also the above central manager 500 optionally and preferably supports sharing the CDN traffic between the customer and one or more CDN vendors, represented by customer edge 522 and one or more of CDN vendors 526 or 560, for example optionally to reduce cost and improve performance.

Overall, for the present invention, provision of balancing and/or sharing for content distribution preferably provides one or more of cost, Quality of Service/Performance, manageability and/or redundancy, although of course without being limited to these benefits.

For example, a customer may optionally wish to provide content through both a low cost CDN and “best of breed” CDN (ie providing a better QoE and hence presumably more expensive), by balancing content delivery between these two different CDNs. For specific regions and/or types of content for example, the low cost CDN may be selected while for other specific regions and/or types of content, the best of breed CDN may be selected. Optionally a plurality of such different conditions may be selected while balancing content distribution through these different mechanisms.

The selection of a particular target may also feature a weighting function, in which different proportions of the content may be provided through a plurality of different targets (for example 40% to one target and 60% to another target).

While the invention has been described with respect to a limited number of embodiments, it will be appreciated that many variations, modifications and other applications of the invention may be made.

What is claimed is:

1. A method for managing content distribution resources for a customer, comprising:
providing a CDN (content distribution network) center for managing content distribution;
providing a plurality of CDNs;
providing content of the customer to be distributed; and
selecting at least one of said plurality of CDNs for distributing the content by said CDN center.

2. The method of claim 1, wherein said selecting said at least one of said plurality of CDNs comprises determining a load at each of said plurality of CDNs; and selecting said at least one CDN according to said load.

3. The method of claim 2, wherein said selecting said at least one CDN according to said load is performed for load balancing between said plurality of CDNs.

4. The method of claim 1, wherein said selecting said at least one of said plurality of CDNs comprises determining sharing of resources between said plurality of resources, such that said at least one CDN is selected according to said sharing of resources.

5. The method of claim 4, wherein said sharing of resources further comprises providing a customer distribution resource and wherein said selecting said at least one of said plurality of CDNs further comprises optionally selecting said customer distribution resource to distribute the content.

6. The method of claim 5, wherein said customer distribution resource is controlled by another customer, other than the customer requesting distribution of the content.

7. The method of claim 4, wherein said selecting said at least one CDN according to said sharing of resources further comprises selecting said at least one CDN according to one or more of a plurality of parameters.

8. The method of claim 7, wherein said one or more parameters are selected from the group consisting of load balancing, optimal content distribution, minimum bandwidth sharing, maximum bandwidth sharing, latency and cost.

9. The method of claim 1, further comprising providing a customer edge and a partner edge; and determining whether to distribute content from the customer by the partner edge or the customer edge.

10. The method of claim 9, further comprising distributing the content through at least one of the CDN, the partner edge or the customer edge.

11. The method of claim 10, wherein said determining whether to distribute the content through said CDN, the partner edge or the customer edge, or a combination thereof, is performed according to a policy of the customer.

12. The method of claim 11, wherein said policy includes a limit on bandwidth sharing.

13. The method of claim 12, wherein said limit is determined at least partially according to cost.

14. The method of claim 11, wherein said policy includes a requirement for quality of experience.

15. The method of claim 11, wherein said policy includes a requirement for a cost limit.

16. The method of claim 11, wherein said policy includes a requirement for redundancy of content delivery mechanisms.

17. The method of claim 9, further comprising predicting bandwidth usage by the customer edge and the partner edge by the CDN center to determine any unused bandwidth; and selecting one or more of the customer edge and the partner edge according to availability of unused bandwidth.

18. The method of claim 17, wherein said predicting the bandwidth usage comprising collecting one or more statistics of bandwidth usage of each customer; and analyzing the one or more statistics.

19. The method of claim 18, wherein the one or more statistics are selected from the group consisting of bandwidth used in the past hour, bandwidth used in the past 24 hours, bandwidth used in the past week, bandwidth used in the past month and real time bandwidth usage.

20. The method of claim 19, wherein said predicting the bandwidth further comprises determining whether current bandwidth usage represents a peak such that sharing with at least one other customer is not performed.

21. The method of claim 20, wherein said predicting the bandwidth further comprises determining a deviation from historical bandwidth usage; and predicting future bandwidth usage according to actual bandwidth used and the deviation.

22. The method of claim 21, wherein said determining the deviation further comprises comparing actual and historical bandwidth usage according to a statistical model.

23. The method of claim 22, further comprising providing a peer to peer content distribution mechanism; and determining whether to distribute content from the customer by the peer to peer content distribution mechanism.

24. The method of claim 23, further comprising managing distribution of content for a customer through one of a plurality of CDNs and optionally through a non-CDN resource.

25. A method for predicting bandwidth usage, comprising:
measuring one or more of a plurality of statistics selected from the group consisting of bandwidth used in the past hour, bandwidth used in the past 24 hours, bandwidth used in the past week, bandwidth used in the past month and real time bandwidth usage;
determining a deviation from historical bandwidth usage; and
predicting future bandwidth usage according to actual bandwidth used and said deviation.

26. The method of claim 25, wherein said determining the deviation further comprises comparing actual and historical bandwidth usage according to a statistical model.

27. The method of claim 26, further comprising determining actual bandwidth usage; comparing the actual bandwidth usage to the predicted future bandwidth usage; and if different, then adjusting a further future prediction according to the difference.

28. The method of claim 27, further comprising determining whether a trend for current bandwidth usage is for a peak.

29. The method of claim 27, further comprising adjusting said further future prediction according to seasonal historical bandwidth data.

30. A method for content distribution to an end user for one of a plurality of customers, the method comprising:
obtaining information regarding the end user, said information including a geographical location and a desired content related activity;
determining a list of potential routing targets, wherein at least one potential routing target is controlled by a partner and wherein at least one potential routing target is controlled by a CDN (content distribution network); and
selecting at least one routing target according to a selection policy, wherein said selection policy includes a parameter related to resource sharing for content distribution.

31. The method of claim 30, wherein said selecting the at least one routing target further comprises:
determining a route for providing the information to the end user; and
selecting the at least one routing target at least partially according to the route.

32. The method of claim 31, wherein said determining the route is performed according to one or more of a result of a bandwidth prediction algorithm; edge monitoring; BGP (Border Gateway Protocol) result; actual physical route being used; latency of the route; popularity of the information;
geographical parameters; time based parameters; type of content; site health and cost of the route.

33. The method of claim 32, wherein said at least one routing target is further selected according to one or more of a low distance or a low latency separation from the distribution center by the end user.

34. The method of claim 33, wherein said routing target is selected according to an anycasting protocol response.

35. A method for sharing content distribution resources between content distribution networks (CDNs), comprising:
providing a management center for managing content distribution for a plurality of CDNs;
predicting bandwidth usage by each CDN by said management center to determine any unused bandwidth; and
determining whether to distribute content from at least one CDN according to said unused bandwidth.

36. A system for content distribution, comprising:
a CDN center;
a plurality of customer edges; and
a CDN edge;
wherein said CDN center determines whether to distribute the content through said CDN edge or through one of said customer edges.

37. The system of claim 36, further comprising: a plurality of CDN edges from a plurality of CDN vendors, wherein the CDN center further determines whether to distribute the content through one of the plurality of the CDN edges or through one or more of the customer edges, or a combination thereof.
